(19) United States
(12) Patent Application Publication
(10) Pub. No.: US 2005/0070617 A1
(43) Pub. Date: Mar. 31, 2005

(54) Low density rigid polyamide foam and method for production

(75) Inventor: Walter Rudolf Harfmann, Weddington, NC (US)

Correspondence Address: Harfmann Technology Inc., 424 Amanda Drive, Weddington, NC, 28104, US

(73) Assignee: Harfmann Technology, Inc., Weddington, NC (US)

(21) Appl. No.: 10/672,563

(22) Filed: Sep. 29, 2003

(51) Int. Cl. C08J 9/00

(52) U.S. Cl. 521/50

(57) ABSTRACT

Low density, rigid, Polyamide Foam is produced via reactive extrusion wherein an additive is used to improve melt strength. A particulate nucleator and physical gas are added during extrusion. The homogenous mixture is extruded through an orifice to produce useful articles.

### TECHNICAL FIELD

The present invention generally relates to a method and system for producing foam articles. More particularly, the present invention relates to a method and system for producing low density polyamide foam and articles made thereof.

### BACKGROUND INFORMATION

Polymeric foams have found utility in many fields of use. Food packaging, insulation applications, automotive uses are just to name a few. Different foams have different properties and therefore different utility. For example, soft olefin foams have been found useful for packaging of shock sensitive components. Styrenic foams are widely used for food packaging. Higher density foams, such as PVC foams, are useful for producing structural profiles. All of these foams have limitations. Few have service limits above 200 F. Some are brittle, others have poor stiffness characteristics, still others perform poorly in weather exposed conditions. Polyamides have excellent properties with regard to all of these characteristics. Polyamides have excellent stiffness, low brittleness, can be used for extended periods at elevated temperatures, and perform well in weatherable applications.

However, the poor melt strength and high cost of polyamides have limited the utility of this material. Due to the poor melt strength, foam components produced from polyamides have been limited to densities greater than 0.5 grams per cubic centimeter. At typical prices that have historically been at least two to three times the price of commodity resins, the use of polyamides have been limited to high end applications.

Thus a need exists for a method to produce low density polyamide foam and articles made thereof.

### SUMMARY OF THE INVENTION

The invention encompasses the production of low density rigid polyamide foam via reactive in-situ modification of the polyamide to create the melt strength necessary to blow and maintain low density foam. To this end, functionalized polymers such as Clariant CESA-EXTEND 1586 have been found to be useful. The invention further encompasses the production of useful articles from the foam. Such articles exhibit low weight and high strength and would be particularly useful in automotive and aerospace applications.

### DESCRIPTION OF PRIOR ART

Nylon foam was disclosed by Purvis, U.S. Pat. No. 4,070,426. Purvis produced nylon foam to a specific gravity of 0.52 g/cc. No examples are cited or mention is made of nylon foam at specific gravity less than 0.5 g/cc.

Kosa, U.S. Pat. Nos. 4,442,234 and 4,464,491 discloses the production of flexible nylon foam using a batch reaction method. Although mention is made that the technology can be used to produce rigid foam by one skilled in the art, in the nineteen years since this patent was issued, no such foam has been developed.

Gehlen, et. al. discloses a method to produce nylon foam in U.S. Pat. No. 6,586,489 that may contain up to 50% nylon, however in my invention, no such limitation on composition exists.

Muschiatti, U.S. Pat. No. 5,229,432 discloses a method for the production of low density polyester foam. Included within the text of the patent are blowing agents useful for the production of such foam. This patent has been found particularly useful for preparation of polyamide foams. In preparing polyester foams, Muschiatti developed the process technology necessary to process high temperature foam systems, however, this technology was never extended to polyamides.

Johnson, et. al. disclose the use of polytetraflouroethylene particles for the nucleation of polyester foams. Such particles have been found useful in the nucleation of polyamide foams.

### PREFERRED EMBODIMENT

In the preferred embodiment, polyamide resin, preferably Nylon 6 or Nylon 6,6 is feed into an extrusion line. The formulation also contains a reactive component used to increase melt strength of the polyamide resin. The preferred additive is a functionalized polymer, such as Clariant CESA-EXTEND 1586, Clariant CESA-EXTEND 1598, or Clariant CESA-EXTEND 1599. A particulate nucleator, preferably polytetraflouroethylene with a particle size of 1 to 10 microns, is used for cell size control. Dupont's Zonyl MP1400 has been found to be particularly effective as a nucleator. The preferred physical blowing agent for foaming the mixture is cyclopentane.

The extrusion line has specific areas of functionality consisting of, in order, forwarding of solids, melting and pressurization of solids, injection of physical blowing agent, mixing, tempering of the melt, and pressure release. This functionality is most preferably designed into a twin screw extruder, however, a tandem extrusion line wherein the primary extruder may be either a twin or single screw extruder and the secondary extruder is a single screw extruder or other cooling device such as a planetary gear extruder may also be used. Equipment technology for the production of foam is well documented and generally known by one skilled in the art.

### EXAMPLE DATA

The following composition was fed into a tandem extrusion line:

| BASF B73QP Nylon 6 | Balance |
|---|---|
| Clariant CESA-EXTEND 1586 | 2.5% |
| Zonyl MP-1400 | 2.0% |
| Cyclopentane | 2.2% |

This composition was fed into the primary extruder at a rate of 46.3 lb/hr.

The line conditions were:

Temperature

Primary Extruder

| | |
|---|---|
| Zone 1 | 252 F. |
| Zone 2 | 426 F. |
| Zone 3 | 482 F. |
| Zone 4 | 479 F. |
| Zone 5 | 480 F. |

Crossover

| | |
|---|---|
| Screen Changer | 500 F. |
| Melt Pump | 502 F. |

Secondary Extruder

| | |
|---|---|
| Zone 1 | 439 F. |
| Zone 2 | 440 F. |
| Zone 3 | 441 F. |
| Zone 4 | 441 F. |

Die

| | |
|---|---|
| Zone 1 | 440 F. |
| Zone 2 | 441 F. |

Pressures

| | |
|---|---|
| Blowing Agent Injection | 455 psi |
| Primary Extruder Exit | 2170 psi |
| Gear Pump Inlet | 1780 psi |
| Gear Pump Exit | 2800 psi |
| Die | 380 psi |

Machine Conditions

Primary Extruder

| | | |
|---|---|---|
| Speed | 80.4 | rpm |
| Current | 16.4 | amps |

Melt Pump

| | | |
|---|---|---|
| Speed | 14.7 | rpm |

Secondary Extruder

| | | |
|---|---|---|
| Speed | 14.0 | rpm |
| Current | 13.9 | amps |

The product produced using these conditions has a density of 0.27 grams per cubic centimeter and an average cell size of 0.8 millimeters.

1) Rigid Polyamide foam having a specific gravity of less than 0.5 g/cc.

2) A method for the production of Low Density Rigid Polyamide foam wherein the formulation is fed into an extrusion system; the formulation consisting of a polyamide, a functionalized polymer additive, a physical nucleator, and a physical blowing agent. The formulation is first melted and pressurized. The physical blowing agent is then injected and mixed. The homogenous melt is tempered and then pressure is released through a die orifice creating a useful shape.

3) The method of claim 2 wherein the amount of physical nucleator is between 0.1 and 3.0 percent by weight.

4) The method of claim 3 wherein the nucleator is polytetraflouroethylene.

5) The method of claim 2 wherein the physical blowing agent is between 1% and 10%.

6) The method of claim 5 wherein the physical blowing agent is selected from a group consisting of hydrocarbons, hydroflourocarbons, hydrochlorocarbons, hydrochloroflourocarbons, argon, nitrogen, or carbon dioxide.

7) The method of claim 6 wherein the physical blowing agent selected is cyclopentane.

8) The method of claim 2 wherein the functionalized polymer is between 0.1 and 3.0%.

9) The method of claim 8 wherein the functionalized polymer chosen is Clariant CESA-EXTEND 1586.

10) The product of claim 1 wherein the polyamide foam is used to produce useful articles via profile extrusion.

11) The product of claim 1 wherein the polyamide foam is used to produce sheet, which is subsequently formed to produce useful articles.
